(19) United States
(12) Patent Application Publication
(10) Pub. No.: US 2020/0077577 A1
(43) Pub. Date: Mar. 12, 2020

(54) PIVOTABLE RAKE ASSEMBLY

(71) Applicants: Hughie House, Montgomery, TX (US); Alfiya House, Montgomery, TX (US)

(72) Inventors: Hughie House, Montgomery, TX (US); Alfiya House, Montgomery, TX (US)

(21) Appl. No.: 16/124,592

(22) Filed: Sep. 7, 2018

(51) Int. Cl. A01D 7/00

(52) U.S. Cl. CPC A01D 7/00

(57) ABSTRACT

A pivotable rake assembly for raking a roof without using a ladder includes a handle is gripped for raking. A head is pivotally coupled to the handle such that the head is positionable at a selected angle with respect to the handle. A rake is pivotally coupled to the head such that the rake is positioned at the selected angle with respect to the handle. In this way the rake can engage a roof of a building when a user is standing on ground. The rake has a plurality of tines to rake debris from the roof top.

### CROSS-REFERENCE TO RELATED APPLICATIONS

### Statement Regarding Federally Sponsored Research or Development

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to rake devices and more particularly pertains to a new rake device for raking a roof without using a ladder.

### BRIEF SUMMARY OF THE INVENTION

An embodiment of the disclosure meets the needs presented above by generally comprising a handle is gripped for raking. A head is pivotally coupled to the handle such that the head is positionable at a selected angle with respect to the handle. A rake is pivotally coupled to the head such that the rake is positioned at the selected angle with respect to the handle. In this way the rake can engage a roof of a building when a user is standing on ground. The rake has a plurality of tines to rake debris from the roof top.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top view of a pivotable rake assembly according to an embodiment of the disclosure.

FIG. 2 is a left side view of an embodiment of the disclosure.

FIG. 3 is a right side view of an embodiment of the disclosure showing a head being angled.

FIG. 4 is a perspective in-use view of an embodiment of the disclosure.

FIG. 5 is a perspective view of a brush attachment of an embodiment of the disclosure.

FIG. 6 is a perspective view of a pivot of an embodiment of the disclosure.

### DETAILED DESCRIPTION OF THE INVENTION

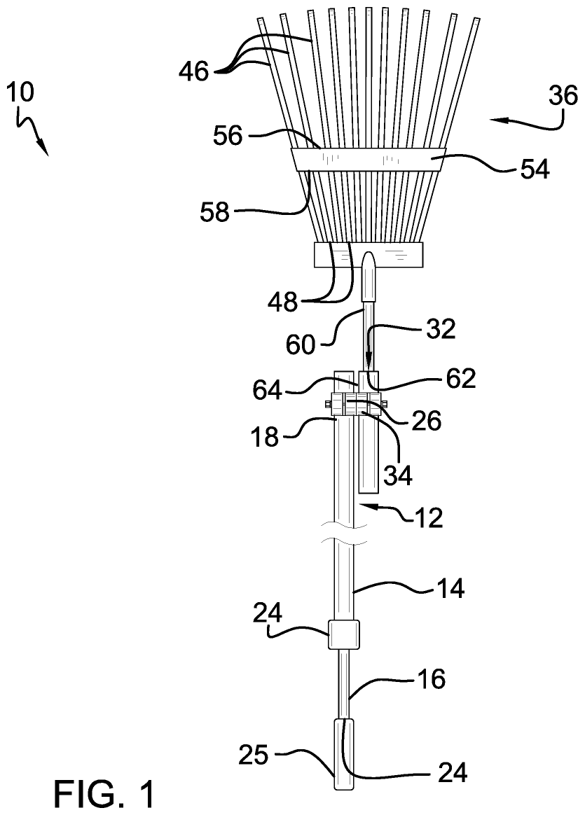

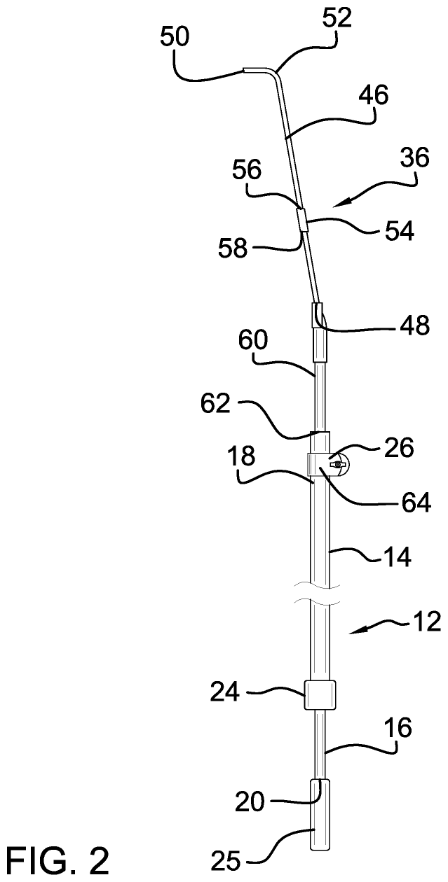

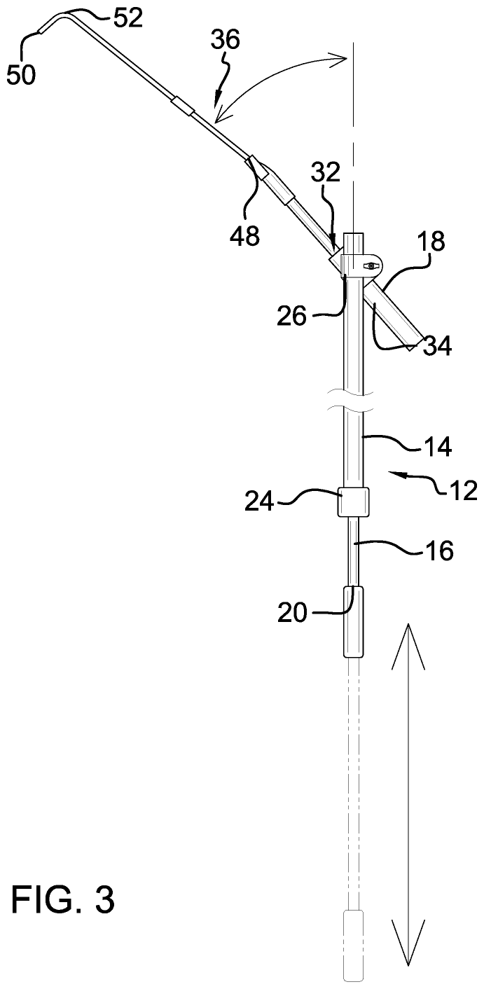

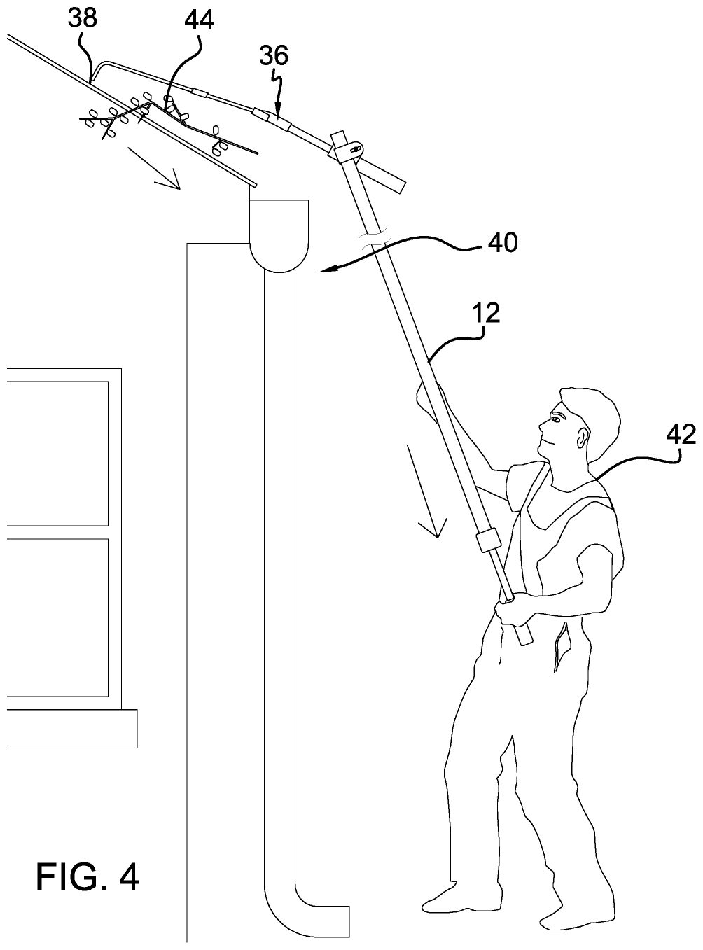

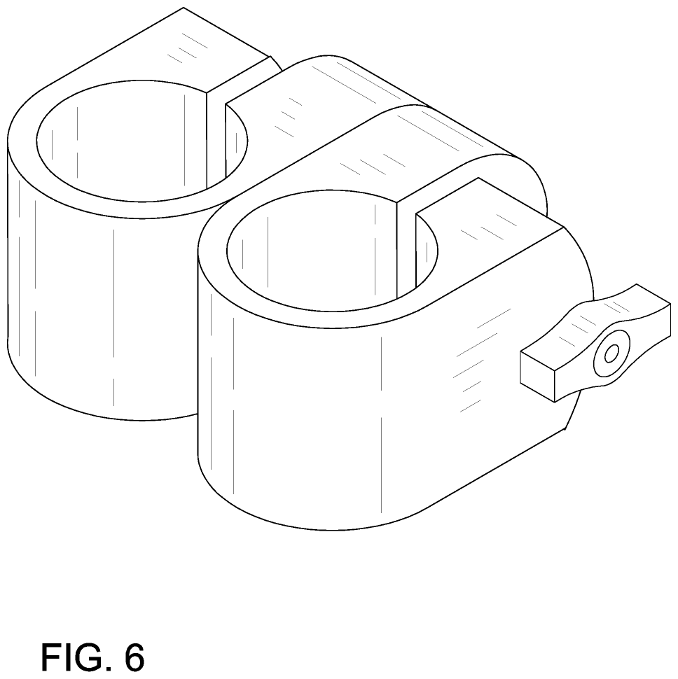

With reference now to the drawings, and in particular to FIGS. 1 through 6 thereof, a new rake device embodying the principles and concepts of an embodiment of the disclosure and generally designated by the reference numeral 10 will be described.

As best illustrated in FIGS. 1 through 6, the pivotable rake assembly 10 generally comprises a handle 12 that is gripped for raking. The handle 12 has a first portion 14 that is slidably coupled to a second portion 16 such that the handle 12 has a telescopically adjustable length. The first portion 14 has a first end 18 and the second portion 16 has a second end 20. A coupler 24 is rotatably coupled around the first portion 14 of the handle 12. The coupler 24 frictionally engages the second portion 16 when the coupler 24 is tightened thereby retaining the handle 12 at a selected length. A grip 25 may be coupled around the second portion 16 for gripping and the grip 25 may be aligned with the second end 20.

A pivot 15 is provided that includes a first sleeve 17 and a second sleeve 19. Each of the first 17 and second 19 sleeves has an outer wall 21. Moreover, the outer wall 21 of the first sleeve 17 has a coupling point 23 that is rotatably coupled to a coupling point 23 on the outer wall 21 of the second sleeve 19. Each of the first 17 and second 19 sleeves is rotatable about an axis extending through the coupling point 23,23 on each of the first 17 and second 19 sleeves. Additionally, the first sleeve 17 insertably receives the first end 18 of the first portion 14 of the handle 12.

A head 26 is coupled to the pivot 15 such that the head 26 is positionable at a selected angle with respect to the handle 12. The head 26 has a first end 28 and a second end 30, and the first end 28 of the head 26 has a well 32 extending toward the second end 30 of the head 26. The second sleeve 19 insertably receives the second end 30 of the head 26. A fastener 34 extends through the first 17 and second 19 sleeves 12 and the fastener 34 tightens the first sleeve 17 against the second sleeve 19. In this way the head 26 is retained at the selected angle with respect to the handle 12. The fastener 34 may comprise a nut and a bolt or other type of releasable fastener.

A rake 36 is pivotally coupled to the head 26 such that the rake 36 is positioned at the selected angle with respect to the handle 12. In this way the rake 36 can be positioned to engage a roof 38 of a building 40 when a user 42 is standing on ground. Thus, the user 42 can rake debris 44, such as leaves or the like, from the roof 38 without the use of a ladder. The rake 36 has a plurality of tines 46 to rake debris 44 from the roof 38. Each of the tines 46 has a primary end 48 and a secondary end 50, and each of the tines 46 has a bend 52 thereon adjacent to the primary end 48 such that the primary end 48 is directed downwardly for engaging the debris 44.

The rake 36 includes a member 54 that has a front surface 56 and a back surface 58. The secondary end 50 of each of the tines 46 is coupled to the front surface 56, and the tines 46 are spaced apart from each other and are distributed along the front surface 56. A rod 60 is coupled to and extends away from the back surface 58 of the member 54. The rod 60 has a distal end 62 with respect to the member 54, the rod 60 is centrally positioned on the member 54 and the well 32 in the head 26 insertably receives the distal end 62 of the rod 60.

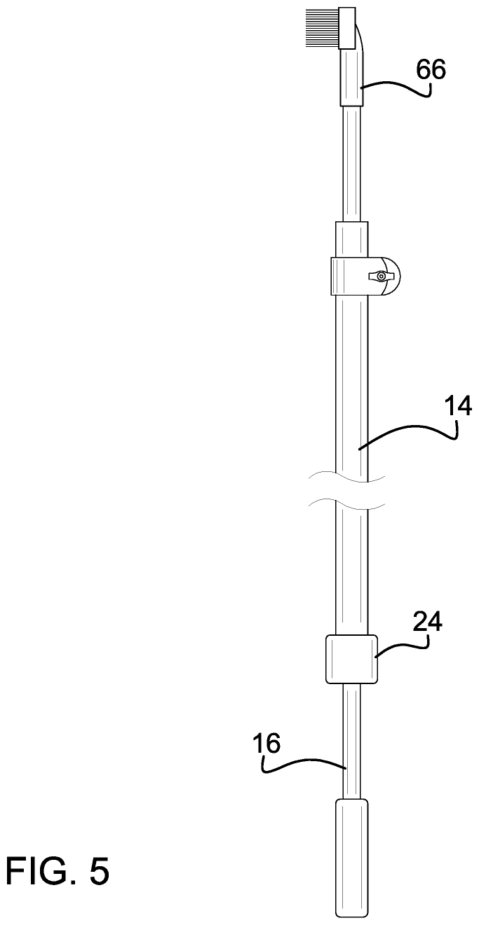

A lock 64 is movably coupled to the head 26. The lock 64 engages the rod 60 when the rod 60 is inserted into the well 32 thereby retaining the rod 60 in the well 32. The lock 64 disengages the rod 60 when the lock 64 is manipulated thereby facilitating the rod 60 to be removed from the well 32. The lock 64 may comprise a ball that is biased inwardly on the head 26 to engage a corresponding detent in the rod 60 or other type of mechanically releasable lock 64. As shown in FIG. 5, a brush attachment 66 may be provided, and the brush attachment 66 may be releasably coupled to the head 26 in the same manner as the rake 36. Thus, the brush can brush debris 44 from the roof 38.

In use, the head 26 is positioned at the selected angle on the handle 12 and the fastener 34 is manipulated to retain the head 26 at the selected angle. The telescopic length of the handle 12 is adjusted and the coupler 24 is tightened to retain the handle 12 at the selected length. The handle 12 is manipulated to position the rake 36 on the roof 38 of the building 40 thereby facilitating the roof 38 to be raked. In this way the debris 44, such as leaves, branches and other objects commonly found on roofs, can be removed from the roof 38 without requiring a user 42 to climb a ladder or the like.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A pivotable rake assembly having a head being pivotal on a handle for raking debris from a roof top, said assembly comprising:
a handle being gripped for raking;
a pivot being removably coupled to said handle;
a head being coupled to said pivot such that said head is positionable at a selected angle with respect to said handle; and
a rake being pivotally coupled to said head such that said rake is positioned at said selected angle with respect to said handle wherein said rake is configured to engage a roof of a building when a user is standing on ground, said rake having a plurality of tines wherein said tines are configured to rake debris from the roof top.

2. The assembly according to claim 1, wherein:
said handle has a first portion being slidably coupled to a second portion such that said handle has a telescopically adjustable length, said first portion having a first end, said second portion having a second end; and
a coupler being rotatably coupled around said first portion of said handle, said coupler frictionally engaging said second portion when said coupler is tightened thereby retaining said handle at a selected length.

3. The assembly according to claim 2, wherein said pivot includes a first sleeve and a second sleeve, each of said first and second sleeve having an outer wall, said outer wall of said first sleeve having a coupling point being rotatably coupled to a coupling point on said outer wall of said second sleeve, each of said first and second sleeves being rotatable about an axis extending through said coupling point on each of said first and second sleeves, first sleeve insertably receiving said first end of said first portion of said handle.

4. The assembly according to claim 3, wherein said head has a first end and a second end, said first end of said head having a well extending toward said second end of said head, said second sleeve insertably receiving said first end of said head such that said head is positionable at a selected angle with respect to said handle when said second sleeve is pivoted on said first sleeve.

5. The assembly according to claim 4, further comprising a fastener extending through said first sleeve and engaging said second sleeve, said fastener tightening said first sleeve against said second sleeve when said fastener is tightened for retaining said head at said selected angle with said handle.

6. The assembly according to claim 1, further comprising:
each of said tines having a primary end and a secondary end, each of said tines having a bend thereon adjacent to said primary end such that said primary end is directed downwardly for engaging the debris; and
a member having a front surface and a back surface, said secondary end of each of said tines being coupled to said front surface, said tines being spaced apart from each other and being distributed along said front surface.

7. The assembly according to claim 4, further comprising:
a well in said head;
a rod being coupled to and extending away from said back surface of said member, said rod having a distal end with respect to said member, said rod being centrally positioned on said member, said well in said head insertably receiving said distal end of said rod; and
a lock being movably coupled to said head, said lock engaging said rod when said rod is inserted into said well thereby retaining said rod in said well, said lock disengaging said rod when said lock is manipulated thereby facilitating said rod to be removed from said well.

8. A pivotable rake assembly having a head being pivotal on a handle for raking debris from a roof top, said assembly comprising:
a handle being gripped for raking, said handle having a first portion being slidably coupled to a second portion such that said handle has a telescopically adjustable length, said first portion having a first end, said second portion having a second end;
a coupler being rotatably coupled around said first portion of said handle, said coupler frictionally engaging said second portion when said coupler is tightened thereby retaining said handle at a selected length;
a pivot including a first sleeve and a second sleeve, each of said first and second sleeves having an outer wall, said outer wall of said first sleeve having a coupling point being rotatably coupled to a coupling point on said outer wall of said second sleeve, each of said first and second sleeves being rotatable about an axis extending through said coupling point on each of said first and second sleeves, first sleeve insertably receiving said first end of said first portion of said handle;
a head being pivotally coupled to said handle such that said head is positionable at a selected angle with respect to said handle, said head having a first end and a second end, said first end of said head having a well extending toward said second end of said head, said slot in said first end of said handle insertably receiving said second end of said head;
a fastener extending through said first sleeve and engaging said second sleeve, said fastener tightening said first sleeve against said second sleeve when said fastener is tightened for retaining said head at said selected angle with said handle;
a rake being pivotally coupled to said head such that said rake is positioned at said selected angle with respect to said handle wherein said rake is configured to engage a roof of a building when a user is standing on ground, said rake having a plurality of tines wherein said tines are configured to rake debris from the roof top, each of said tines having a primary end and a secondary end, each of said tines having a bend thereon adjacent to said primary end such that said primary end is directed downwardly for engaging the debris;
a member having a front surface and a back surface, said secondary end of each of said tines being coupled to said front surface, said tines being spaced apart from each other and being distributed along said front surface;
a rod being coupled to and extending away from said back surface of said member, said rod having a distal end with respect to said member, said rod being centrally positioned on said member, said well in said head insertably receiving said distal end of said rod; and
a lock being movably coupled to said head, said lock engaging said rod when said rod is inserted into said well thereby retaining said rod in said well, said lock disengaging said rod when said lock is manipulated thereby facilitating said rod to be removed from said well.
